(19) United States
(12) Patent Application Publication
(10) Pub. No.: US 2025/0145033 A1
(43) Pub. Date: May 8, 2025

(54) CHARGING BOX

(71) Applicant: ISUZU MOTORS LIMITED, Yokohama-shi (JP)

(72) Inventor: Hiroki SUGAWARA, Fujisawa-shi (JP)

(21) Appl. No.: 18/824,254

(22) Filed: Sep. 4, 2024

(30) Foreign Application Priority Data
Nov. 2, 2023 (JP) 2023-188336

(51) Int. Cl. B60L 53/16; H01R 13/633

(52) U.S. Cl. CPC B60L 53/16; H01R 13/633

(57) ABSTRACT

A charging box includes a locking part that receives a control signal and locks a connector to a power receiver, a releasing part that is provided within a housing and releases a lock with the locking part, a fastening member that is attached to a first wall in a manner to be loosened, and a wire that includes one end portion in a longitudinal direction coupled to the releasing part and another end portion coupled to the fastening member. The fastening member includes a free-wheeling mechanism that rotates freely with respect to the another end portion of the wire when the fastening member is rotated, and the wire operates the releasing part to release the lock, when the fastening member that has been loosened moves in a direction away from the housing.

### CROSS-REFERENCE TO RELATED APPLICATIONS

The present application claims priority to Japanese Patent Applications number 2023-188336, filed on Nov. 2, 2023 contents of which are incorporated herein by reference in their entirety.

### BACKGROUND OF THE INVENTION

The present disclosure relates to a charging box of a vehicle that can be charged by an external source.

A vehicle is provided with a charging box that charges a battery by having a charging gun connected thereto (see Japanese Unexamined Patent Application Publication No. 2019-84891). For safety reasons, the charging box is provided with a locking part that locks the charging gun so that the charging gun cannot be disengaged during charging, and the locking part operates upon receiving a control signal from a controller.

If lightning strikes during charging, for example, a control signal is not properly transmitted to the locking part from the controller, resulting in a failure to release the lock. In addition, although a releasing part for manual operation is provided in the charging box, the charging box has to be disassembled to operate the releasing part.

### BRIEF SUMMARY OF THE INVENTION

The present disclosure focuses on this point, and an object thereof is to easily release a connector lock in a charging box.

A first aspect of the present disclosure provides a charging box attached to a body frame and capable of receiving power from an external power supply device, including a power receiver that is provided on a first wall exposed to the outside of a housing and is configured to be coupled to a connector of the external power supply device, a locking part that receives a control signal and locks the connector to the power receiver, a releasing part that is provided within the housing and releases a lock with the locking part, a fastening member that is attached to the first wall in a manner to be loosened, and a wire that includes i) one end portion in a longitudinal direction coupled to the releasing part and ii) another end portion coupled to the fastening member, wherein the fastening member includes a free-wheeling mechanism that rotates freely with respect to the another end portion of the wire when the fastening member is rotated, and the wire operates the releasing part to release the lock, when the fastening member that has been loosened moves in a direction away from the housing.

### BRIEF DESCRIPTION OF THE DRAWINGS

FIG. 1 is a schematic diagram showing a charging box 1 with a charging gun 100 attached.

FIG. 2 is a front view of the charging box 1.

FIG. 3 is a schematic diagram showing a locking part 30 and a releasing part 40 of the charging box 1.

FIG. 4 is a schematic diagram showing a fastening member 50 and a wire 60.

FIG. 5 is a schematic diagram showing an example of a free-wheeling mechanism 70.

FIG. 6 is a schematic diagram illustrating a mode in which a fastening member 50 is rotated with a screwdriver 150 when the charging gun 100 is attached to the charging box 1.

FIG. 7 is a schematic diagram showing a state of the releasing part 40 when the fastening member 50 is pulled.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### <Configuration of Charging Box>

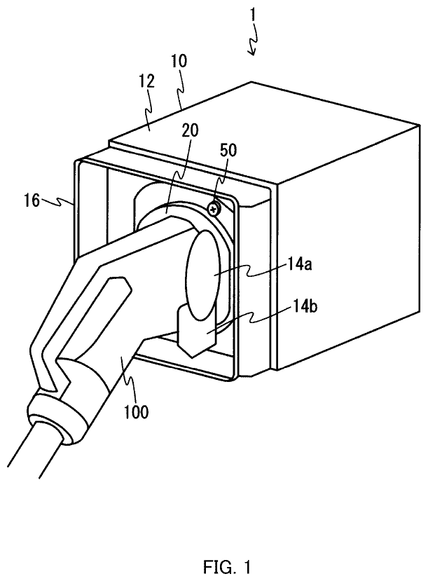

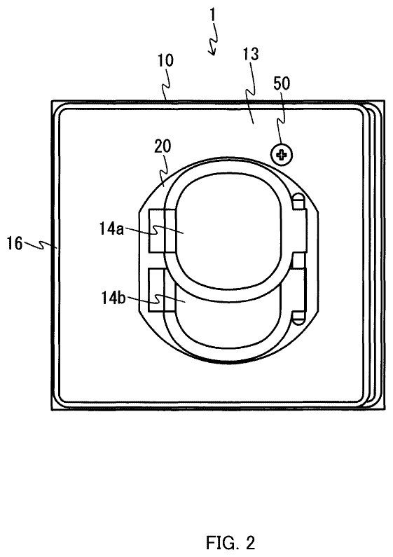

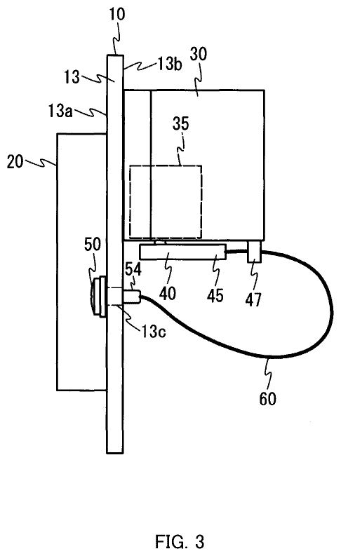

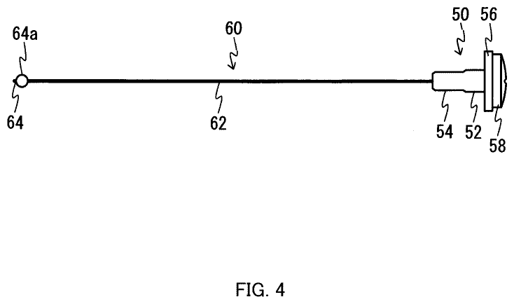

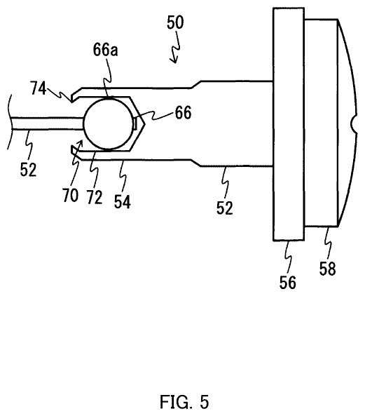

FIG. 1 is a schematic diagram showing a charging box 1 with a charging gun 100 attached. FIG. 2 is a front view of the charging box 1. FIG. 3 is a schematic diagram showing a locking part 30 and a releasing part 40 of the charging box 1. FIG. 4 is a schematic diagram showing a fastening member 50 and a wire 60. FIG. 5 is a schematic diagram showing an example of a free-wheeling mechanism 70. It should be noted that, in FIG. 3, a portion of the charging box 1 is shown for convenience of description.

The charging box 1 is a device for receiving power from an external power supply device. Specifically, the charging box 1 charges a battery with electricity received via a connector of the external power supply device. The charging box 1 is coupled to a battery via a cable. The charging box 1 is mounted on a body frame of a vehicle with a frame structure, such as a truck or a bus. Therefore, the charging box 1 is exposed to the outside.

As illustrated in FIGS. 1 to 3, the charging box 1 includes a housing 10, a power receiver 20, a locking part 30, a releasing part 40, a fastening member 50, and a wire 60.

The housing 10 is box-shaped. The housing 10 is secured to the body frame via a bracket. As illustrated in FIG. 1, the housing 10 includes a main body 12, lids 14a and 14b, and a collar portion 16.

The main body 12 here has a rectangular parallelepiped shape. The locking part 30, the releasing part 40, and the like are disposed inside the main body 12 (see FIG. 3). A front wall 13 of the main body 12 is provided with the power receiver 20 to which the charging gun 100, which is a connector of an external power supply device, can be coupled. As shown in FIG. 1, the front wall 13 can be exposed to the outside of the housing 10.

The lids 14a and 14b are openable/closable lids. The lids 14a and 14b cover a charging port of the power receiver 20 when closed. The charging gun 100 is coupled to the charging port of the power receiver 20 in a state where the lids 14a and 14b are opened. Each of the lids 14a and 14b is opened and closed about a hinge.

The collar portion 16 is formed with a square shape so as to surround the lids 14a and 14b. One axial end (front end in the front-rear direction shown in FIG. 1) of the collar portion 16 is an opening. The charging gun 100 is inserted through the opening. The other axial end of the collar portion 16 is coupled to the front wall 13 of the main body 12. It should be noted that, although not shown in FIG. 1, a door capable of closing or opening the opening of the collar portion 16 is provided. The collar portion 16 is closed by the door when charging is not being performed.

The power receiver 20 receives power from an external power supply device. The power receiver 20 has a charging port to which the charging gun 100 can be coupled. The power receiver 20 receives power from an external power supply device by having the charging gun 100 coupled to the charging port. The power receiver 20 is located at the center of the front wall 13 of the housing 10.

The locking part 30 locks the charging gun 100 to the power receiver 20. The locking part 30 receives a locking command as a control signal for locking, and locks the charging gun 100 to the power receiver 20. As shown in FIG. 3, the locking part 30 is provided within the housing 10. The locking part 30 is provided at a position opposite to the power receiver 20 when viewed from the front wall 13. Specifically, the locking part 30 is provided so as to be in contact with a back surface 13b of the front wall 13 of the housing 10.

The locking part 30 includes an actuator 35 including a motor and a gear therein. Upon receiving a locking command, the actuator 35 operates the motor to engage an engagement member with the charging gun 100, for example, thereby locking the charging gun 100 to the power receiver 20. Further, upon receiving a releasing command as a control signal for releasing the lock, the actuator 35 releases the engagement of the engagement member with the charging gun 100, thereby releasing the lock of the charging gun 100. The locking part 30 here receives a control signal (locking command and releasing command) from an Electronic Control Unit (ECU) of the vehicle.

The releasing part 40 releases the lock on the charging gun 100 with the locking part 30. As shown in FIG. 3, the releasing part 40 is provided within the housing 10 so as to be adjacent to the locking part 30. For example, if lightning strikes during charging, the ECU becomes unable to transmit a releasing command to the locking part 30. In such a case, an operator operates the releasing part 40 to release the charging gun 100.

The releasing part 40 has a displaceable releasing lever 45. The releasing part 40 is provided at a position adjacent to the back surface 13b of the front wall 13 within the housing 10. The releasing part 40 is provided so as to be manually operated by an operator. Specifically, the operator can release the lock on the charging gun 100 with the locking part 30 by pulling the releasing lever 45 in a direction away from the back surface 13b of the front wall 13 (in other words, toward the center of the housing 10).

The fastening member 50 is attached to the front wall 13 in a manner to be loosened. Here, the fastening member 50 is attached to a through hole 13c penetrating through the front wall 13 from the front surface 13a to the back surface 13b. Here, the fastening member 50 is a screw. As shown in FIG. 4, the fastening member 50 includes a threaded portion 52, a distal end portion 54, a washer 56, and a head portion 58.

The threaded portion 52 is formed with a male thread. The fastening member 50 is secured to the front wall 13 by having the threaded portion 52 engage with a female thread formed in the through hole 13c of the front wall 13. The operator can remove the fastening member 50 from the front wall 13 by rotating and loosening the fastening member 50 using a driver.

The distal end portion 54 is a shaft portion that is closer to the distal end than the threaded portion 52 in the axial direction. The distal end portion 54 is located within the housing 10. The distal end portion 54 is coupled to the wire 60. No thread is formed on the outer peripheral surface of the distal end portion 54. The diameter of the distal end portion 54 is smaller than the diameter of the threaded portion 52. As will be described later, the distal end portion 54 is provided with a free-wheeling mechanism 70 in which the fastening member 50 rotates freely with respect to the wire 60 when the fastening member 50 is rotated.

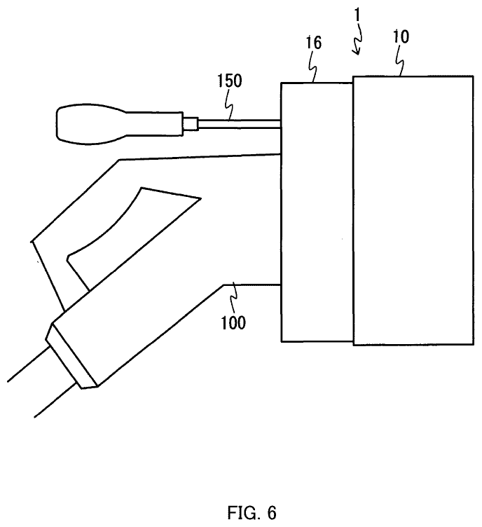

The head portion 58 is in contact with the front surface 13a of the front wall 13. The head portion 58 is located in front of the front surface 13a. A groove that accommodates a driver (a screwdriver 150 shown in FIG. 6) is formed on a top surface of the head portion 58. The washer 56 is a waterproof seal washer. The washer 56 is made of an elastically deformable material. The washer 56 is compressed between the head portion 58 and the front wall 13 when the fastening member 50 is tightened. The washer 56 is compressed in this manner, thereby preventing water from entering the housing 10 through the through hole 13c of the front wall 13.

As shown in FIG. 3, the wire 60 couples the releasing lever 45 of the releasing part 40 and the distal end portion 54 of the fastening member 50. As shown in FIG. 4, the wire 60 includes a wire portion 62, one end portion 64, and another end portion 66.

The wire portion 62 is made of metal. For example, the wire 60 is made of stainless steel for its tensile strength, friction resistance, and robustness. However, the present disclosure is not limited thereto, and the wire 60 may be made of nylon or polypropylene which is a synthetic fiber.

The one end portion 64 of the wire 60 in the longitudinal direction is coupled to the releasing part 40, and the another end portion 66 of the wire 60 in the longitudinal direction is coupled to the fastening member 50. Specifically, the one end portion 64 of the wire 60 is coupled to the releasing lever 45 of the releasing part 40 (see FIG. 3), and the another end portion 66 of the wire 60 is coupled to the distal end portion 54 of the fastening member 50 (see FIG. 5). The wire 60 is located within the housing 10 when the fastening member 50 is attached to the front wall.

The one end portion 64 of the wire 60 is provided with a spherical body 64a as shown in FIG. 4. The one end portion 64 is coupled to the releasing lever 45. When the wire portion 62 is pulled from the another end portion 66, the releasing lever 45 coupled to the one end portion 64 is pulled, thereby releasing the lock. It should be noted that the one end portion 64 does not have to be provided with the spherical body 64a.

The another end portion 66 of the wire 60 is provided with a spherical body 66a as shown in FIG. 5. The spherical body 66a has the same size as the spherical body 64a. The spherical body 66a is inserted into the distal end portion 54 of the fastening member 50. Specifically, the spherical body 66a is inserted into the free-wheeling mechanism 70 provided at the distal end portion 54.

The free-wheeling mechanism 70 is a mechanism in which the fastening member 50 rotates freely with respect to the another end portion 66 (spherical body 66a) of the wire 60 when the fastening member 50 rotates. Specifically, when the operator loosens or tightens the fastening member 50, the free-wheeling mechanism 70 allows the fastening member 50 to remain stationary with respect to the another end portion 66. This prevents twisting of the wire due to the rotation of the fastening member 50. As shown in FIG. 5, the free-wheeling mechanism 70 includes a cavity 72 and a restricting portion 74.

The cavity 72 is formed in the distal end portion 54 of the fastening member 50. The cavity 72 is formed as a recess by creating a recess in a distal end surface of the distal end portion 54 with a predetermined depth. The spherical body 66a of the another end portion 66 of the wire 60 is inserted into the cavity 72. The diameter of the cavity 72 is larger than the diameter of the spherical body 66a of the another end portion 66 of the wire 60. Therefore, the spherical body 66a is rotatable in the cavity 72.

FIG. 6 is a schematic diagram illustrating a mode in which a fastening member 50 is rotated with the screwdriver 150 when the charging gun 100 is attached to the charging box 1. As described above, if lightning strikes during charging and the ECU is unable to transmit a control signal (command for releasing the lock) to the locking part 30, the operator loosens the fastening member 50 with the screwdriver 150 to manually release the lock. That is, the operator rotates the fastening member 50 with the screwdriver 150 engaged with the head portion 58 of the fastening member 50.

If the wire 60 is coupled to the fastening member 50 unlike the present embodiment, the wire portion 62 will be twisted because the rotational force is transmitted to the wire portion 62 of the wire 60 when the operator rotates the fastening member 50 with the screwdriver 150 (for example, tightens or loosens the fastening member 50). In particular, if the wire portion 62 is made of metal, twisting of the wire portion 62 is likely to occur.

In contrast, in the case of the present embodiment, the wire portion 62 of the wire 60 can be prevented from being twisted because the rotational force of the fastening member 50 is not transmitted to the wire portion 62 as the spherical body 66a is rotatable in the cavity 72 when the operator rotates the fastening member 50 with the screwdriver 150. If the wire portion 62 is made of metal as in the present embodiment, the effect of preventing twisting of the wire portion 62 is more effectively exhibited.

The restricting portion 74 restricts the spherical body 66a from falling away from the cavity 72. The restricting portion 74 is formed at the distal end of the distal end portion 54. Specifically, the restricting portion 74 has a shape in which the distal end of the distal end portion 54 is bent toward its center so as to reduce the inner diameter of the cavity 72. In this way, the spherical body 66a is caught by the restriction portion 74 when the operator pulls the fastening member 50, thereby preventing the spherical body 66a from falling away from the cavity 72. As a result, when the operator moves the fastening member 50 toward the front, the wire portion 62 moves toward the front as well.

In the above description, the free-wheeling mechanism 70 includes i) the cavity 72 in which the spherical body 66a can rotate therein and ii) the restricting portion 74, but the present disclosure is not limited thereto. The free-wheeling mechanism 70 may have another structure as long as the fastening member 50 can rotate freely with respect to the wire 60 when the fastening member 50 is rotated.

The fastening member 50 and the wire 60 described above are included, and so the operator can release the lock without disassembling the housing 10. When the loosened fastening member 50 moves away from the housing 10, the wire 60 pulls the releasing lever 45 to operate the releasing part 40 to release the lock.

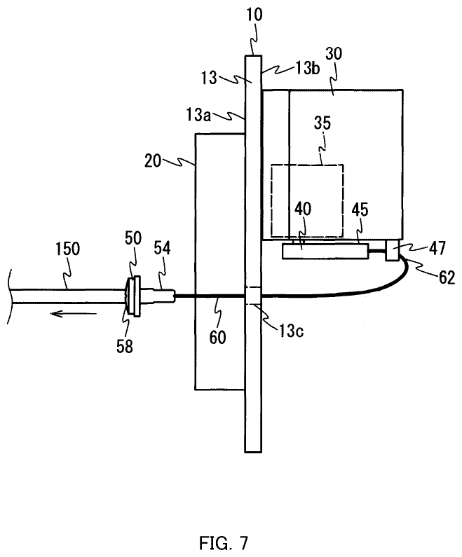

FIG. 7 is a schematic diagram showing a state of the releasing part 40 when the fastening member 50 is pulled. The operator pulls the screwdriver 150, to which the head portion 58 of the loosened fastening member 50 is attracted by magnetic force, in a direction away from the housing 10 (toward the front), whereby the fastening member 50 also moves away from the housing 10. As the fastening member 50 moves toward the front, the wire 60 coupled to the fastening member 50 also moves toward the front. When the wire 60 is pulled through the through hole 13c of the front wall 13 by the fastening member 50, the wire 60 pulls the releasing lever 45 to operate the releasing part 40 so as to release the lock. In this way, the operator can release the lock by loosening and pulling the fastening member 50 coupled to the releasing lever 45 via the wire 60.

As shown in FIG. 7, the releasing part 40 is provided with a guide part 47 that guides the position of a portion of the wire 60 near the one end portion 64. The guide part 47 extends a portion of the wire 60 near the one end portion 64 along the normal direction of the back surface 13b of the front wall 13. The guide part 47 is provided at a position farther away from the back surface 13b of the front wall 13 than the releasing lever 45. The guide part 47 has a hollow portion through which the wire portion 62 of the wire 60 is inserted.

The above-described guide part 47 is provided, and so the wire portion 62 of the wire 60 within the housing 10 can maintain a folded-back posture at the guide part 47. Further, the hollow portion is provided in the guide part 47 so that the hollow portion functions as a support part that supports the wire portion 62 when the fastening member 50 is pulled, therefore the wire portion 62 can be kept taut and be easily pulled. This allows the wire portion 62 to easily pass through the through hole 13c when the fastening member 50 is pulled, and thus the releasing lever 45 is easily pulled.

### Effects of Embodiment

In the charging box 1 of the above-described embodiment, the fastening member 50 includes the free-wheeling mechanism 70 that rotates freely with respect to the another end portion 66 of the wire 60 when the fastening member 50 is rotated. The wire 60 then operates the releasing part 40 to release the lock when the loosened fastening member 50 moves away from the housing 10.

The above configuration allows the wire 60 coupled to the fastening member 50 to be prevented from being twisted when the operator loosens the fastening member 50. And then, the operator pulls the fastening member 50 toward the front with the wire 60 not being twisted, and so the wire 60 can operate the releasing part 40 to appropriately release the lock. As a result, the operator can manually release the charging gun 100 without disassembling the housing 10.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A charging box attached to a body frame and capable of receiving power from an external power supply device, comprising:
a power receiver that is provided on a first wall exposed to the outside of a housing and is configured to be coupled to a connector of the external power supply device;
a locking part that receives a control signal and locks the connector to the power receiver;
a releasing part that is provided within the housing and releases a lock with the locking part;
a fastening member that is attached to the first wall in a manner to be loosened; and
a wire that includes i) one end portion in a longitudinal direction coupled to the releasing part and ii) another end portion coupled to the fastening member, wherein
the fastening member includes a free-wheeling mechanism that rotates freely with respect to the another end portion of the wire when the fastening member is rotated, and
the wire operates the releasing part to release the lock, when the fastening member that has been loosened moves in a direction away from the housing.

2. The charging box according to claim 1, wherein
the fastening member is attached to a through hole penetrating the first wall,
the another end portion of the wire is coupled to a distal end portion of the fastening member, and
the wire operates the releasing part to release the lock when the wire is pulled through the through hole by the fastening member that has been loosened.

3. The charging box according to claim 2, wherein
the fastening member further includes:
a head portion that is in contact with a front surface of the first wall and accommodates a driver; and
a threaded portion that engages with a female thread formed in the first wall, wherein
the distal end portion of the fastening member is located within the housing.

4. The charging box according to claim 1, wherein
the releasing part includes a displaceable lever, and
the one end portion of the wire is coupled to the lever.

5. The charging box according to claim 1, wherein
a spherical body is provided to the other end of the wire, and
the spherical body is rotatably inserted into a cavity at a distal end of the fastening member.

6. The charging box according to claim 5, wherein
a restricting portion for restricting the spherical body from falling away from the cavity is provided to the distal end of the fastening member.

7. The charging box according to claim 1, wherein
the releasing part is provided at a position adjacent to a back surface of the first wall within the housing, and
the charging box further comprises:
a guide part that is provided at a position farther away from the back surface than the releasing part and extends a portion of the wire near the one end portion along a normal direction of the back surface.

8. The charging box according to claim 7, wherein
the guide part includes a hollow portion through which the wire is inserted, and
the hollow portion supports the wire pulled by the fastening member that has been loosened.

9. The charging box according to claim 1, wherein
the wire is made of metal.
